(19) United States
(12) Patent Application Publication
(10) Pub. No.: US 2017/0091971 A1
(43) Pub. Date: Mar. 30, 2017

(54) DEVICE, SYSTEM, METHOD, AND PROGRAM FOR DISPLAYING IMAGE TAKEN BY UNINHABITED AIRBORNE VEHICLE

(71) Applicant: OPTiM Corporation, Saga (JP)

(72) Inventor: Shunji Sugaya, Tokyo (JP)

(21) Appl. No.: 14/982,327

(22) Filed: Dec. 29, 2015

(30) Foreign Application Priority Data
Sep. 28, 2015 (JP) 2015-189734

(51) Int. Cl. G06T 11/60

(52) U.S. Cl. CPC G06T 11/60

(57) ABSTRACT

The invention is to display an image taken by an uninhabited airborne vehicle to appeal to viewers to easily know where the image is taken. The device for displaying an image taken by an uninhabited airborne vehicle on a map 100 includes an image memory unit 131 that associates and stores an image taken by the uninhabited airborne vehicle with location information on the uninhabited airborne vehicle 200 at the timing of when the image is taken, to superimpose and display the image on a location in the map based on location information associated with the image.

### CROSS REFERENCE TO RELATED APPLICATIONS

This application claims priority to Japanese Patent Application No. 2015-189734 filed on Sep. 28, 2015, the entire contents of which are incorporated by reference herein.

### TECHNICAL FIELD

The present invention relates to a device, a system, a method, and a program for displaying an image taken by an uninhabited airborne vehicle.

### BACKGROUND ART

Recently, uninhabited airborne vehicles that are called drones have become common, which have enabled uninhabited airborne vehicles to more easily take images from the sky. Drones are used to take images of scenic sites to be tourism resources, real-estate properties such as houses and lands, construction sites, disaster sites, and farmlands.

Such images to be displayed desirably intuitively appeals to viewers to know where and how high the images were taken.

A system that specifies the location where images were mainly taken, based on the location information where the images were taken during the flight of an aircraft has been proposed (Patent Document 1).

### CITATION LIST

### Patent Literature

Patent Document 1: JP 2012-189866A

### SUMMARY OF INVENTION

The system of Patent Document 1 uses an imaging location data base containing information on latitude and longitude at which an image was taken and a grid table created by previously dividing a predetermined area into grids to register information on the latitude and the longitude of the image in a corresponding grid in the grid table according to the coordinate. However, the system is only to specify the location at which an image was taken. Therefore, images displayed by this system hardly intuitively appeals to viewers to know where the images were taken from a map.

Moreover, the system of Patent Document 1 specifies the location where images were mainly taken as the representative point but cannot specify the location when only one image was taken at a certain point.

To solve these problems, an objective of the present invention to provide a device, a system, a method, and a program for displaying an image to enable an image taken by an uninhabited airborne vehicle to intuitively appeal to viewers.

According to the first aspect of the present invention, a device for displaying an image taken by an uninhabited airborne vehicle on a map includes:

an image memory unit that associates and stores an image taken by the uninhabited airborne vehicle with location information on the uninhabited airborne vehicle at the timing of when the image is taken; and

a display unit that superimposes and displays the image on a location in the map based on location information associated with the image.

According to the first aspect of the present invention, a device for displaying an image taken by an uninhabited airborne vehicle on a map associates and stores an image taken by the uninhabited airborne vehicle with location information on the uninhabited airborne vehicle at the timing of when the image is taken; and superimposes and displays the image on a location in the map based on location information associated with the image.

The first aspect of the present invention is the category of a device for displaying an image, but the categories of a system, a method, and a program for displaying an image have similar functions and effects.

According to the second aspect of the present invention, in the device according to the first aspect of the present invention,

the location information on the uninhabited airborne vehicle contains location and altitude at which the uninhabited airborne vehicle flies, and

the display unit superimposes and displays the image and the altitude on a location in the map.

According to the second aspect of the present invention, the device according to the first aspect of the present invention has the location information on the uninhabited airborne vehicle containing location and altitude at which the uninhabited airborne vehicle flies, in which the display unit superimposes and displays the image and the altitude on a location in the map.

According to the third aspect of the present invention, in the device according to the first or the second aspect of the present invention,

location-specific information is acquired based on location information associated with the image, and

the display unit superimposes and displays the location-specific information on a location in the map.

According to the third aspect of the present invention, the device according to the first or the second aspect of the present invention acquires location-specific information based on location information associated with the image, in which the display unit superimposes and displays the location-specific information on a location in the map.

The fourth aspect of the present invention provides the device according to the third aspect of the present invention, in which

the location-specific information is a past image specific to a location.

According to the fourth aspect of the present invention, in the device according to the third aspect of the present invention, the location-specific information is a past image specific to a location.

The fifth aspect of the present invention provides the device according to the third aspect of the present invention, in which

the location-specific information is weather information specific to a location.

According to the fifth aspect of the present invention, in the device according to the third aspect of the present invention, the location-specific information is weather information specific to a location.

According to the sixth aspect of the present invention, a system for displaying an image taken by an uninhabited airborne vehicle on a map includes:

an image memory unit that associates and stores an image taken by the uninhabited airborne vehicle with location information on the uninhabited airborne vehicle at the timing of when the image is taken; and

a display unit that superimposes and displays the image on a location in the map based on location information associated with the image.

According to the seventh aspect of the present invention, a method for displaying an image taken by an uninhabited airborne vehicle on a map includes the steps of

associating and storing the image taken by the uninhabited airborne vehicle with location information on the uninhabited airborne vehicle at the timing of when the image is taken; and

superimposing and displaying the image on a location in the map based on location information associated with the image.

According to the eighth aspect of the present invention, a computer program product for use in a device for displaying an image taken by an uninhabited airborne vehicle on a map includes a non-transitory computer usable medium having a set of instructions physically embodied therein, the set of instructions including computer readable program code, which when executed by the device for displaying an image taken by an uninhabited airborne vehicle on a map causes the information processing unit to:

associate and store the image taken by the uninhabited airborne vehicle with location information on the uninhabited airborne vehicle at the timing of when the image is taken; and

superimpose and display the image on a location in the map based on location information associated with the image.

The present invention can provide a device, a system, a method, and a program for displaying an image to enable an image taken by an uninhabited airborne vehicle to intuitively appeal to viewers.

### BRIEF DESCRIPTION OF DRAWINGS

FIG. 1 shows the outline of a device for displaying an image 100 and an uninhabited airborne vehicle 200 according to a preferable embodiment of the present invention.

FIG. 2 is a function block diagram of the device for displaying an image 100 and the uninhabited airborne vehicle 200 to show the relationship among the functions of the devices.

FIG. 3 is a flow chart of the image display process performed by the device for displaying an image 100.

FIG. 4 is one example of the screen of the device for displaying an image 100 to display an image on a map.

FIG. 5 is a function block diagram when the device for displaying an image 100 is communicated with the uninhabited airborne vehicle 200, to show the relationship among the functions of the devices.

FIG. 6 is a flow chart showing that an image taken by the uninhabited airborne vehicle 200 is transmitted to the device for displaying an image 100 and subjected to the image display process.

FIG. 7 is a flow chart of the device for displaying an image 100 to display location-specific information.

FIG. 8 is a function block diagram when the device for displaying an image 100 displays a past image as location-specific information, to show the relationship among the functions of the device.

FIG. 9 is one example of the screen of the device for displaying an image 100 to display a past image as location-specific information.

FIG. 10 is a function block diagram when the device for displaying an image 100 displays weather information specific to a location, as location-specific information, to show the relationship among the functions of the device.

FIG. 11 is one example of the screen of the device for displaying an image 100 to display weather information specific to a location, as location-specific information.

FIG. 12 is a function block diagram when the device for displaying an image 100 displays a past image and weather information specific to a location, as location-specific information, to show the relationship among the functions of the device.

### DESCRIPTION OF EMBODIMENTS

Embodiments of the present invention will be described below with reference to the attached drawings. However, this is illustrative only, and the technological scope of the present invention is not limited thereto.

### Device for Displaying Image 100 and Uninhabited Airborne Vehicle 200

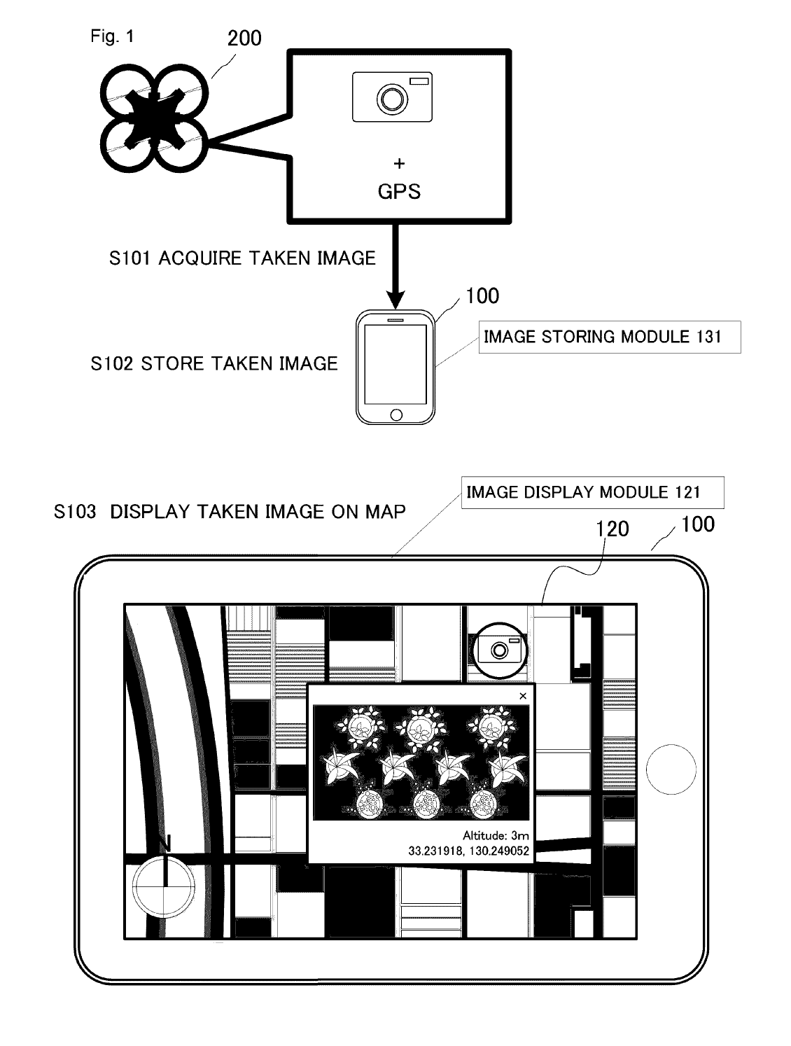

FIG. 1 shows the outline of a device for displaying an image 100 and an uninhabited airborne vehicle 200 according to a preferable embodiment of the present invention. The overview of the present invention will be described below with reference to FIG. 1.

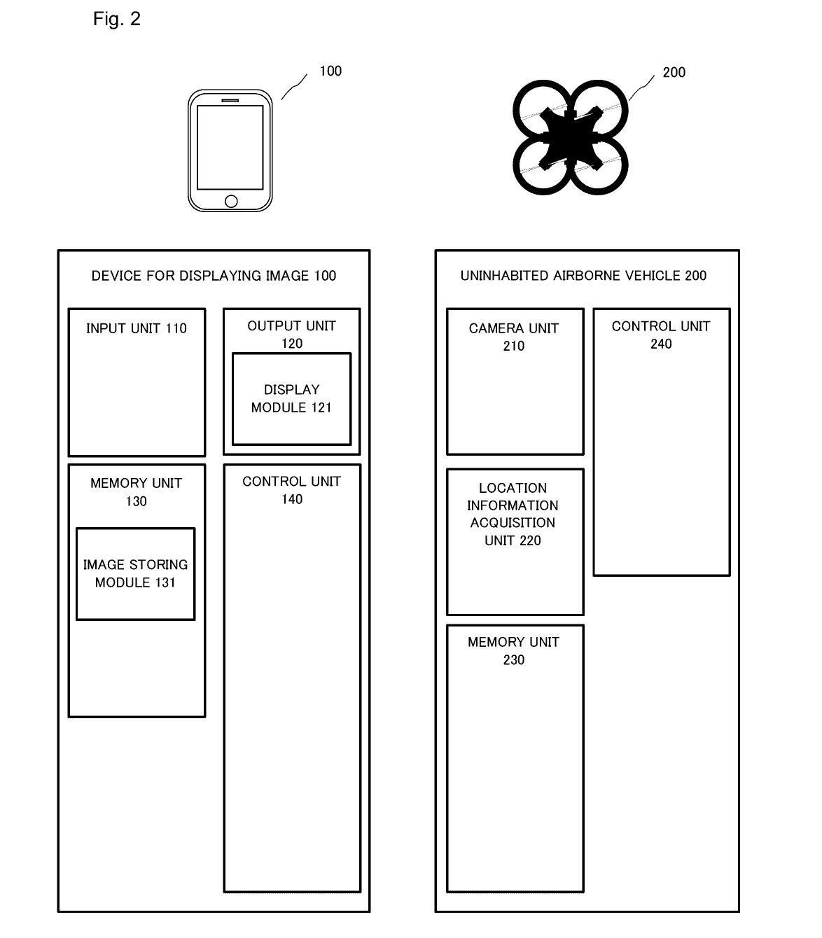

The device for displaying an image 100 is a terminal including an input unit 110, an output unit 120, a memory unit 130, and a control unit as shown in FIG. 2. The output unit 120 includes a display module 121. The memory unit 130 includes an image storing module 131. The uninhabited airborne vehicle 200 is an aircraft capable of unmanned flight, which includes a camera unit 210, a location information acquisition unit 220, a memory unit 230, and a control unit 240.

The device for displaying an image 100 may be a smart phone, a tablet PC, a notebook, a wearable device, or a general information appliance such as a PC provided with a display, which is capable of displaying an image taken by the uninhabited airborne vehicle 200 and a map. The smart phone shown as the device for displaying an image 100 in attached drawings is just one example.

The uninhabited airborne vehicle 200 includes a camera unit 210, which is capable of taking a still or a moving image. The location information acquisition unit 220 has a system capable of acquiring location information provided from a global positioning system (hereinafter referred to as “GPS”), etc. The location information includes latitude, longitude, height, date, time, and direction.

The features of the present invention are not limited by a method of handing over an image from the uninhabited airborne vehicle 200 to the device for displaying an image 100. An image stored in the uninhabited airborne vehicle 200 may be handed over to the device for displaying an image 100 through wired or wireless communication connection. Alternatively, an image stored in the uninhabited airborne vehicle 200 may be stored in a medium such as a memory card, an external hard disk, and an optical disk and handed over to the device for displaying an image 100 through the medium.

First, the device for displaying an image 100 acquires an image taken by the uninhabited airborne vehicle 200 and location information on the uninhabited airborne vehicle 200 at the timing of when the image is taken (step S101).

Then, the image storing module 131 of the memory unit 130 in the device for displaying an image 100 associates and stores the image taken by the uninhabited airborne vehicle 200 with the location information on the uninhabited airborne vehicle 200 at the timing of when the image is taken (step S102).

Finally, the image display module 121 of the display unit 120 in the device for displaying an image 100 displays the image stored in the step S102 at a position aligned to the location information on the uninhabited airborne vehicle 200 at the timing of when the image is taken on a map (step S103).

### Functions

FIG. 2 is a function block diagram of the device for displaying an image 100 and the uninhabited airborne vehicle 200 to show the relationship among the functions of the devices.

The device for displaying an image 100 is a terminal including an input unit 110, an output unit 120, a memory unit 130, and a control unit 140. The output unit 120 includes a display module 121. The memory unit 130 includes an image storing module 131. The uninhabited airborne vehicle 200 is an aircraft capable of unmanned flight, which includes a camera unit 210, a location information acquisition unit 220, a memory unit 230, and a control unit 240.

The device for displaying an image 100 may be a smart phone, a tablet PC, a notebook, a wearable device, or a general information appliance such as a PC provided with a display, which is capable of displaying an image taken by the uninhabited airborne vehicle 200 and a map. The smart phone shown as the device for displaying an image 100 in attached drawings is just one example.

The input unit 110 has a function to perform an instruction necessary for displaying an image and a map. The input unit 110 may include a liquid crystal display to achieve a touch panel function, a key board, a mouse, a pen tablet, and a hardware button on the device, and a microphone to perform voice recognition. The features of the present invention are not limited in particular by an input method.

The output unit 120 includes a display module 121, which has a function to display the image taken by the uninhabited airborne vehicle 200 and a map. The output unit 120 may take various forms such as a liquid crystal display, a PC display, and a projector. The features of the present invention are not limited in particular by an output method.

The memory unit 130 includes a data storage unit such as a hard disk or a semiconductor memory. The memory unit 130 includes an image storing module 131 to store the image taken by the uninhabited airborne vehicle 200 and the location information on the uninhabited airborne vehicle 200 at the timing of when the image is taken. The memory unit 130 can store additional necessary information such as map data.

The control unit 140 includes a central processing unit (hereinafter referred to as “CPU”), a random access memory (hereinafter referred to as “RAM”), and a read only memory (hereinafter referred to as “ROM”).

The uninhabited airborne vehicle 200 is an aircraft capable of unmanned flight, which includes a camera unit 210, a location information acquisition unit 220, a memory unit 230, and a control unit 240. The camera unit 210 is capable of taking a still or a moving image. The location information acquisition unit 220 has a system capable of acquiring location information provided from a global positioning system (hereinafter referred to as “GPS”), etc. The location information includes latitude, longitude, altitude, date, time, and direction.

The image taken by the camera unit 210 is converted into digital data and stored in the memory unit 230. The image may be a still image or moving image. Apart of a moving image can be cut out by the control unit 240 and stored as a still image in the memory unit 230. The obtained taken image is an accurate image with information as much as a user needs. The pixel count and the image quality can be set.

The memory unit 230 includes a data storage unit such as a hard disk or a semiconductor memory. The memory unit 230 may have a configuration to store the image in a medium such as a memory card, an external hard disk, and an optical disk.

The control unit 240 includes CPU, RAM, and ROM.

### Image Display Process

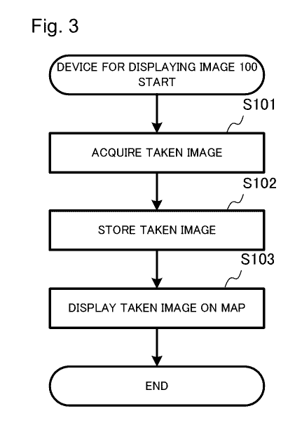

FIG. 3 is a flow chart of the image display process performed by the device for displaying an image 100. The processes performed by the units and the modules of the above-mentioned device are explained below together with this process.

First, the device for displaying an image 100 acquires an image taken by the uninhabited airborne vehicle 200 and location information on the uninhabited airborne vehicle 200 at the timing of when the image is taken (step S101).

The location information herein contains information on at least latitude, longitude, and altitude. The location information may also contain date, time, and direction as needed. The altitude may be delivered based on an ordnance datum or a vertical datum which only have to be used to suit the system. In the same manner, the direction may be delivered based on a true bearing or a magnetic bearing which only have to be used to suit the system.

The data format of the location information may be adjusted to a GPS log data standard or the digital still camera image file format standard (Exif) and only has to be adjusted depending on the system.

How the device for displaying an image 100 acquires an image and location information from the uninhabited airborne vehicle 200 does not really matter herein. An image stored in the uninhabited airborne vehicle 200 may be handed over to the device for displaying an image 100 through wired or wireless communication connection. Alternatively, an image stored in the uninhabited airborne vehicle 200 may be stored in a medium such as a memory card, an external hard disk, and an optical disk and handed over to the device for displaying an image 100 through the medium.

Then, the image storing module 131 of the memory unit 130 in the device for displaying an image 100 associates and stores the image taken by the uninhabited airborne vehicle 200 with the location information on the uninhabited airborne vehicle 200 at the timing of when the image is taken (step S102).

The number of the image does not need to be one. More than one image may be continuously processed. When the image is a moving image, the location at the timing of when the image is taken may be moved. In this case, the image may be associated and stored with location information when the image starts and ends to be taken. Alternatively, the image may be associated and stored with location information corresponding to frames of the moving image.

Finally, the image display module 121 of the display unit 120 in the device for displaying an image 100 displays the image stored in the step S102 at a position aligned to the location information on the uninhabited airborne vehicle 200 at the timing of when the image is taken on a map (step S103).

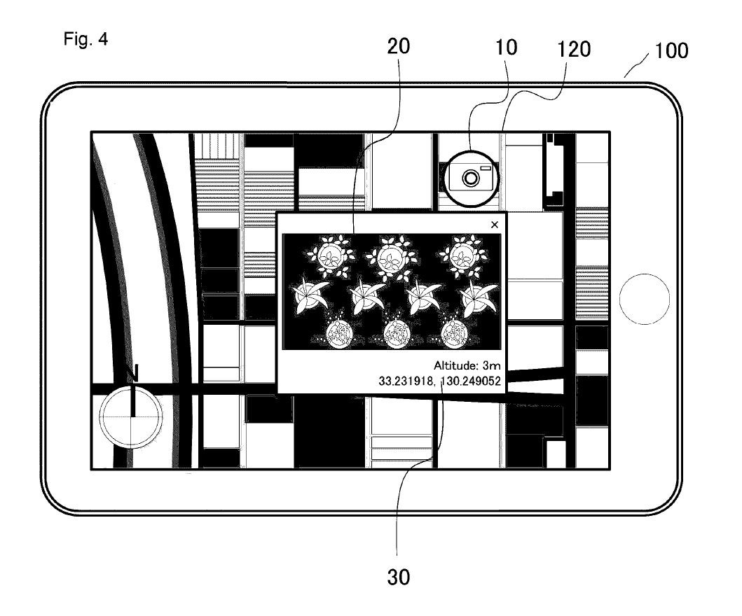

FIG. 4 is one example of the screen of the device for displaying an image 100 to display an image on a map. The display unit 120 displays a map and superimposes and displays an image 20 on a map. Furthermore, the display unit 120 more specifically displays a location at the timing of when the image is taken with a camera mark 10. Still furthermore, the display unit 120 may display information 30 on latitude, longitude, and altitude together with the image 20.

FIG. 4 shows just one display example. Such information may be displayed in a shape such as a balloon from a location at the timing of when the image is taken, in a map. When more than one image is displayed on one map, numbers, characters, and symbols may be used to specifically show the association of an image with a location in a map. Moreover, the size and the number of the image to be displayed may be changed to match the change in the scale size, etc., of a map.

### Image Display Process for Transmitted Image

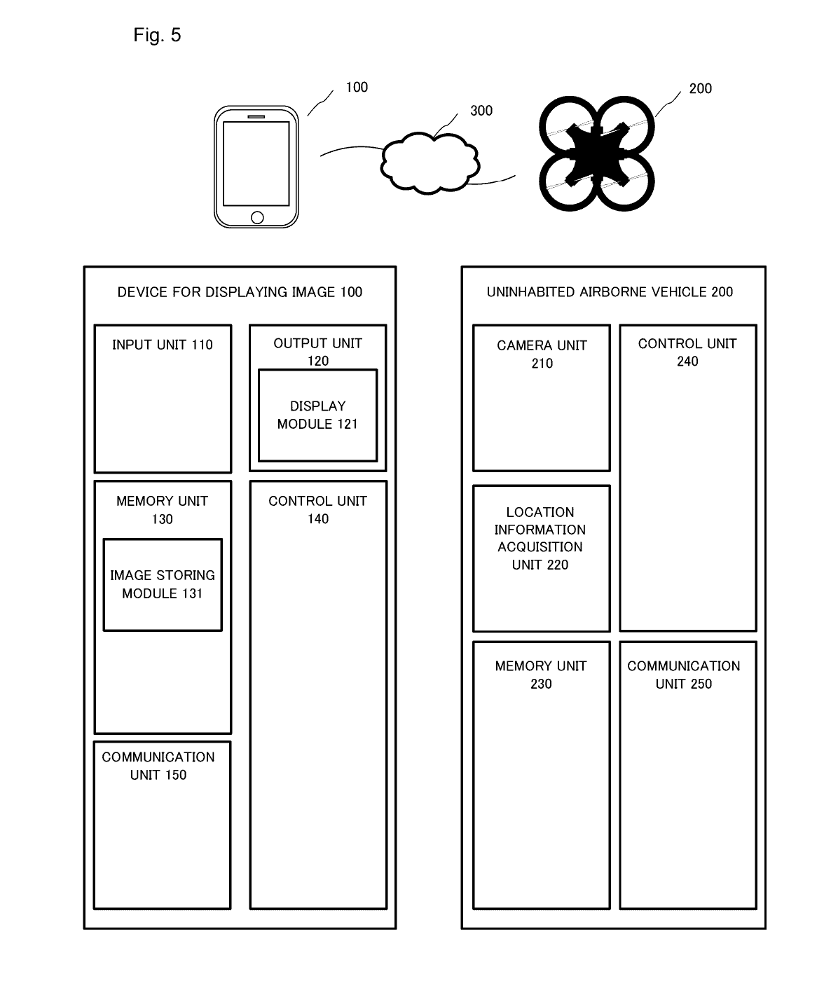

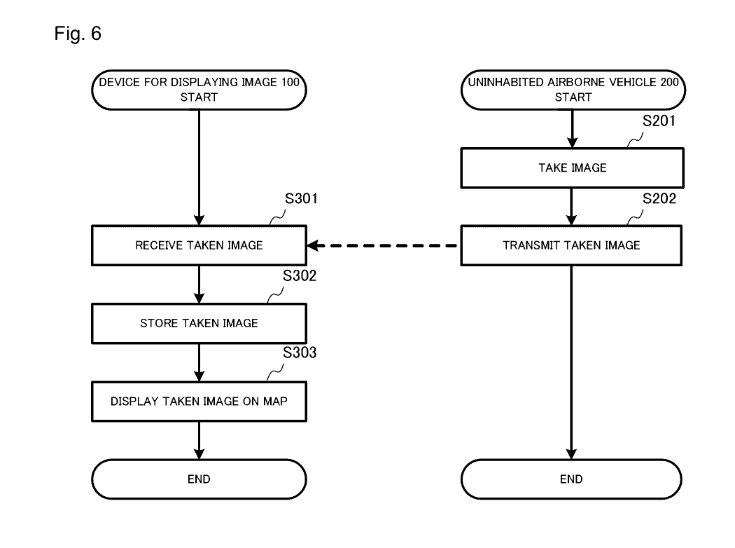

FIG. 5 is a function block diagram when the device for displaying an image 100 is communicated with the uninhabited airborne vehicle 200, to show the relationship among the functions of the devices. FIG. 6 is a flow chart showing that an image taken by the uninhabited airborne vehicle 200 is transmitted to the device for displaying an image 100 and subjected to the image display process.

The device for displaying an image 100 includes a communication unit 150 in addition to the configuration shown in FIG. 2. The uninhabited airborne vehicle 200 also includes a communication unit 250 in addition to the configuration shown in FIG. 2. FIG. 2 shows an example where the device for displaying an image 100 is communicatively connected with the uninhabited airborne vehicle 200 through radiocommunication 300.

First, the uninhabited airborne vehicle 200 take an image with the camera unit 210 while acquiring location information on the uninhabited airborne vehicle 200 with the location information acquisition unit 220 (step S201).

The location information contains information on at least latitude, longitude, and altitude. The location information may also contain date, time, and direction as needed. The altitude may be delivered based on an ordnance datum or a vertical datum which only have to be used to suit the system. In the same manner, the direction may be delivered based on a true bearing or a magnetic bearing which only have to be used to suit the system.

The data format of the location information may be adjusted to a GPS log data standard or the digital still camera image file format standard (Exif) and only has to be adjusted depending on the system.

Then, the uninhabited airborne vehicle 200 transmits the taken image and the location information on the uninhabited airborne vehicle 200 at the timing of when the image is taken to the device for displaying an image 100 (step S202). The uninhabited airborne vehicle 200 may transmit an image whenever taking an image or may transmit images all together after taking all the images.

The device for displaying an image 100 receives the image taken by the uninhabited airborne vehicle 200 and location information on the uninhabited airborne vehicle 200 at the timing of when the image is taken (step S301).

Then, the image storing module 131 of the memory unit 130 in the device for displaying an image 100 associates and stores the image taken by the uninhabited airborne vehicle 200 with the location information on the uninhabited airborne vehicle 200 at the timing of when the image is taken (step S302).

The received images may be continuously subjected to this image storing process. When the image is a moving image, the location at the timing of when the image is taken may be moved. In this case, the image may be associated and stored with location information when a moving image starts and ends to be taken. Alternatively, the image may be associated and stored with location information corresponding to frames of the moving image.

Finally, the image display module 121 of the display unit 120 in the device for displaying an image 100 displays the image stored in the step S302 at a position aligned to the location information on the uninhabited airborne vehicle 200 at the timing of when the image is taken on a map (step S303).

The example of the screen of the device for displaying an image 100 to display an image on a map may be the same as that shown in FIG. 4.

### Location-Specific Information Display Process

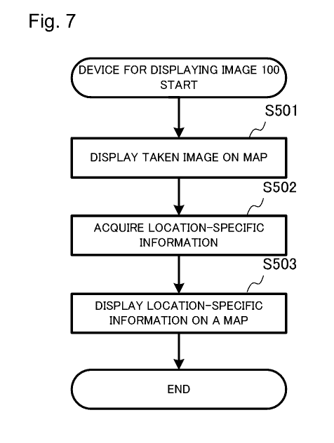

The location-specific information may be acquired based on location information associated with an image and displayed together with the image on a map. FIG. 7 is a flow chart of the device for displaying an image 100 to display location-specific information.

The functions of device for displaying an image 100 when the location-specific information is acquired and displayed on a map will be described below.

First, as shown in FIG. 7, the device for displaying an image 100 displays the image taken by the uninhabited airborne vehicle 200 at a position aligned to the location information on the uninhabited airborne vehicle 200 at the timing of when the image is taken on a map by running the image display module 121 of the display unit 120 (step S501).

Then, the device for displaying an image 100 receives a user's instruction to the input unit 110 and acquires location-specific information (step S502). Examples of the location-specific information may include a past image and weather information specific to a location at which the past image was taken.

Finally, the image display module 121 of the display unit 120 in the device for displaying an image 100 displays the location-specific information acquired in the step S502 on a map (step S503).

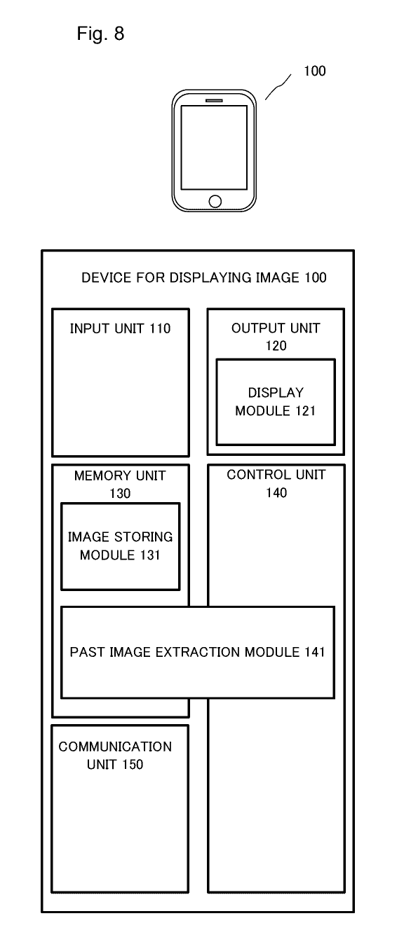

FIG. 8 is a function block diagram when the device for displaying an image 100 displays a past image as location-specific information, to show the relationship among the functions of the device. When the device for displaying an image 100 acquires and displays a past image as location-specific information, the control unit 140 is required to run a past image extraction module 141 to cooperate with the memory unit 130 as shown in FIG. 8. The image extraction module 141 extracts a past image of the location based on location information associated with a current image. The extracted past image may be stored in the memory unit 130 of the device for displaying an image 100, an image database by connection through the communication unit 150, or a medium such as a memory card, an external hard disk, or an optical disk. However, the destination to save may be set by a user.

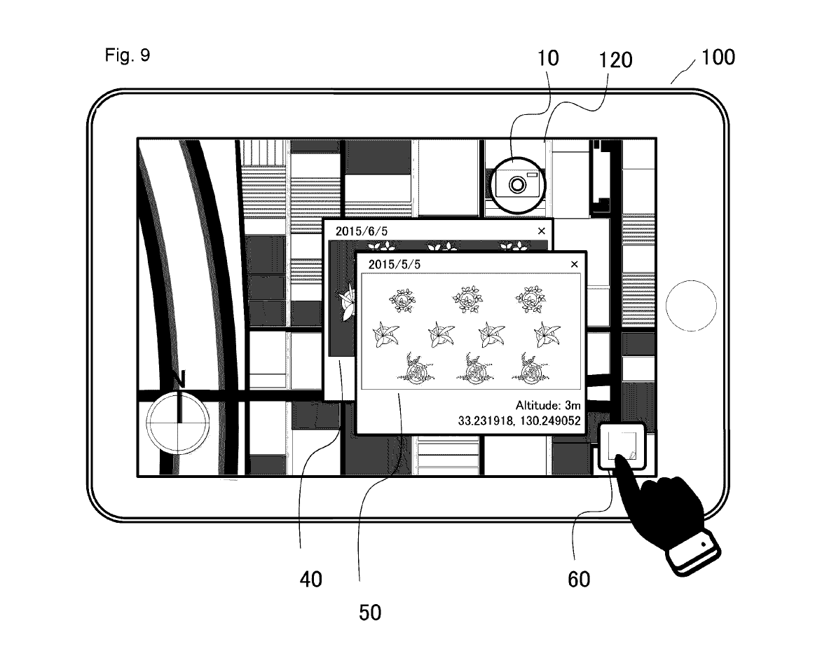

FIG. 9 is one example of the screen of the device for displaying an image 100 to display a past image as location-specific information. The display unit 120 displays a map and superimposes and displays an image 40 on a map. Furthermore, the display unit 120 more specifically displays a location at the timing of when the image is taken with a camera mark 10. Still furthermore, the display unit 120 may display information on latitude, longitude, altitude, date, time, and direction together with the image 40. In FIG. 9, the upper-left of the image 40 displays the date, Jun. 5, 2015, when the image 40 is taken.

In FIG. 9, a past image as location-specific information is acquired by pressing the icon 60 at the lower-right and superimposed and displayed as the past image 50 on a map. The upper-left of the past image 50 displays the date, May 5, 2015, when the past image 50 was taken.

A user may choose whether to superimpose and display a past image as location-specific information on a current image or whether to place and display a past image and a current image side-by-side. Only a date is displayed in this example, but a time may be displayed together with a date. Moreover, when not only one image but also two or more past images exist, all the past images may be displayed. Alternatively, the list of the dates when the past images were taken may be displayed, and only a past image chosen from the list by a user may be displayed.

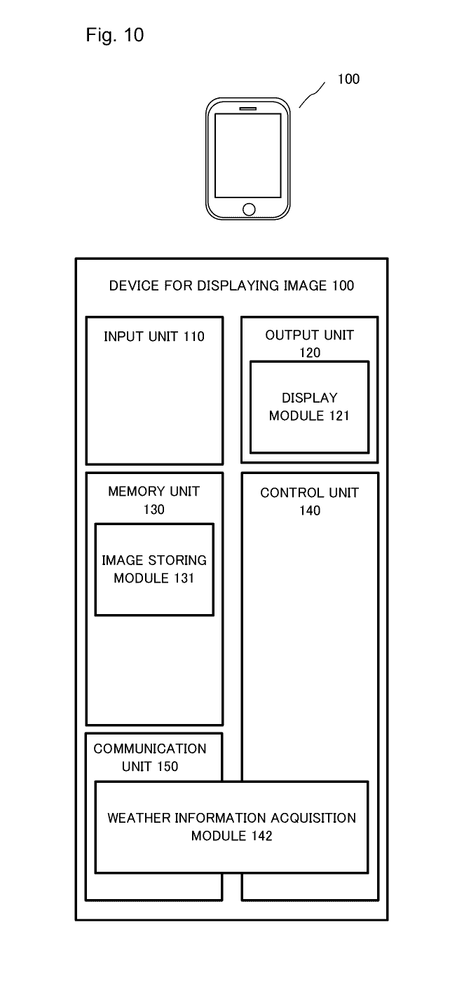

FIG. 10 is a function block diagram when the device for displaying an image 100 displays weather information specific to a location, as location-specific information, to show the relationship among the functions of the device. When displaying weather information specific to a location, as location-specific information, the control unit 140 is required to run a weather information acquisition module 142 in cooperation with the communication unit 150 as shown in FIG. 10. The weather information acquisition module 142 acquires weather information specific to a location based on location information associated with the image. Necessary weather information may be acquired from an outside source such as a weather information service site through the communication unit 150. The features of the present invention are not limited by a method of acquiring weather information.

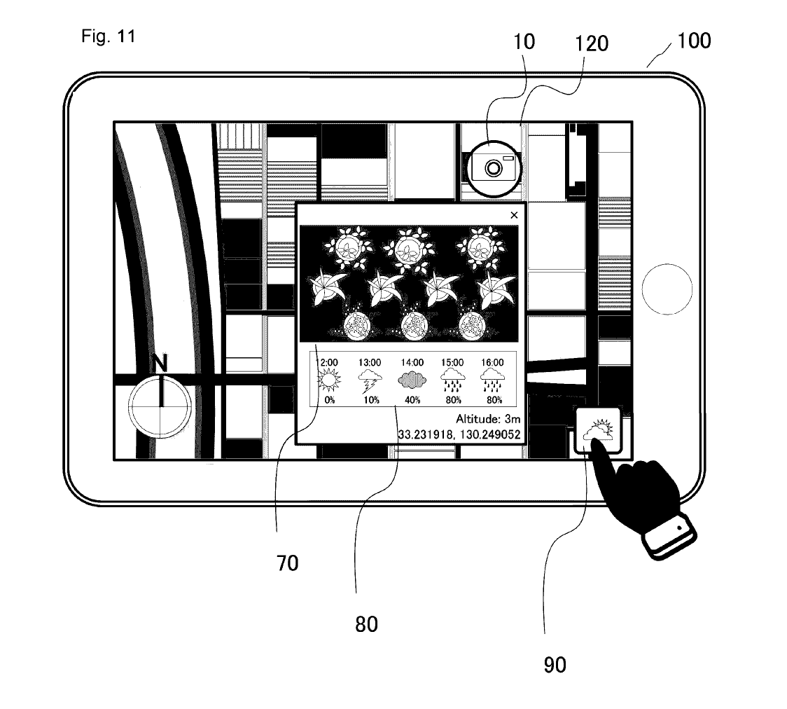

FIG. 11 is one example of the screen of the device for displaying an image 100 to display weather information specific to a location as location-specific information. The display unit 120 displays a map and superimposes and displays an image 70 on a map. Furthermore, the display unit 120 more specifically displays a location at the timing of when the image is taken with a camera mark 10. Still furthermore, the display unit 120 may display information on latitude, longitude, altitude, date, time, and direction together with the image 70. In FIG. 11, the latitude, the longitude, and the altitude when the image 70 is taken are displayed at the lower-right of the image 70.

In FIG. 11, weather information specific to a location as location-specific information is acquired by pressing the icon 90 at the lower-right and displayed as weather information 80 specific to a location in a map. In FIG. 11, hourly weather forecasts and precipitation probabilities are displayed. However, weather information specific to a location, such as average temperature, highest temperature, lowest temperature, humidity, amount of insolation, and precipitation specific to a location, which is necessary for this system, can be displayed. Moreover, weather information may be displayed by using a graph, etc. The content and the display format of weather information may be determined by a user. The features of the present invention are not limited by the content and the display format of weather information.

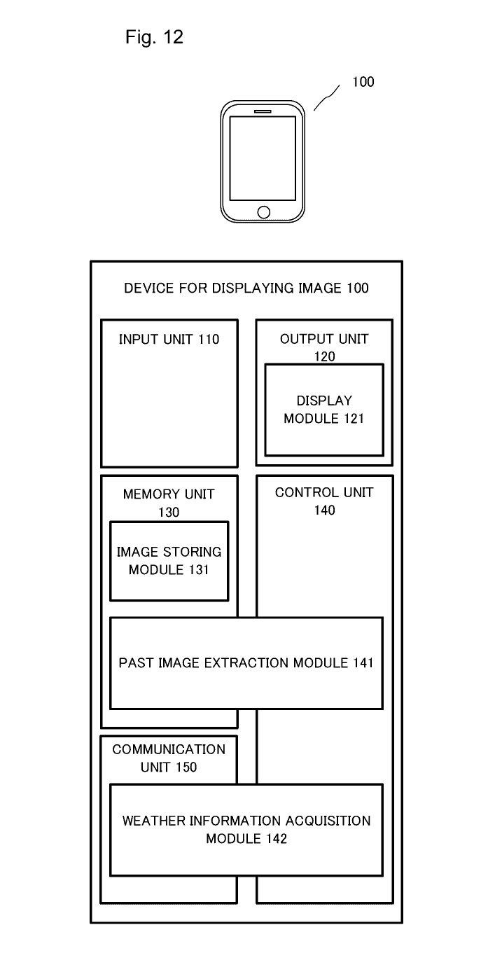

FIG. 12 is a function block diagram when the device for displaying an image 100 displays a past image and weather information specific to a location as location-specific information, to show the relationship among the functions of the device. As location-specific information, both a past image and weather information specific to a location may be acquired. In that case, the control unit 140 runs a past image extraction module 141 and a weather information acquisition module 142 in cooperation with the memory unit 130 and the communication unit 150, respectively, as shown in FIG. 12. The respective operations of the functional blocks are as described above. In this case, the display unit 120 may display both the icon 60 to instruct the display of a past image and the icon 90 to instruct the display of weather information specific to a location.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### REFERENCE SIGNS LIST

100 Device for displaying image

200 Uninhabited airborne vehicle

What is claimed is:

1. A device for displaying an image taken by an uninhabited airborne vehicle on a map, comprising:
an image memory unit that associates and stores an image taken by the uninhabited airborne vehicle with location information on the uninhabited airborne vehicle at the timing of when the image is taken; and
a display unit that superimposes and displays the image on a location in the map based on location information associated with the image.

2. The device according to claim 1, wherein the location information on the uninhabited airborne vehicle contains location and altitude at which the uninhabited airborne vehicle flies, and
the display unit superimposes and displays the image and the altitude on a location in the map.

3. The device according to claim 1, wherein location-specific information is acquired based on location information associated with the image, and
the display unit superimposes and displays the location-specific information on a location in the map.

4. The device according to claim 3, wherein the location-specific information is a past image specific to a location.

5. The device according to claim 3, wherein the location-specific information is weather information specific to a location.

6. A system for displaying an image taken by an uninhabited airborne vehicle on a map, comprising:
an image memory unit that associates and stores an image taken by the uninhabited airborne vehicle with location information on the uninhabited airborne vehicle at the timing of when the image is taken; and
a display unit that superimposes and displays the image on a location in the map based on location information associated with the image.

7. A method for displaying an image taken by an uninhabited airborne vehicle on a map, comprising the steps of
associating and storing the image taken by the uninhabited airborne vehicle with location information on the uninhabited airborne vehicle at the timing of when the image is taken; and
superimposing and displaying the image on a location in the map based on location information associated with the image.

8. A computer program product for use in a device for displaying an image taken by an uninhabited airborne vehicle on a map comprising a non-transitory computer usable medium having a set of instructions physically embodied therein, the set of instructions including computer readable program code, which when executed by the device for displaying an image taken by an uninhabited airborne vehicle on a map causes the information processing unit to:
associate and store the image taken by the uninhabited airborne vehicle with location information on the uninhabited airborne vehicle at the timing of when the image is taken; and
superimpose and display the image on a location in the map based on location information associated with the image.
